(19) United States
(12) Patent Application Publication
(10) Pub. No.: US 2013/0111108 A1
(43) Pub. Date: May 2, 2013

(54) SOLID STATE DRIVE AND METHOD FOR CONTROLLING CACHE MEMORY THEREOF

(71) Applicants: Yi-Jen Chen, Hsinchu (TW); Chi-Sian Chuang, Hsinchu (TW); Yen-Chung Chen, Hsinchu (TW); Yun-Tzuo Lai, Hsinchu (TW)

(72) Inventors: Yi-Jen Chen, Hsinchu (TW); Chi-Sian Chuang, Hsinchu (TW); Yen-Chung Chen, Hsinchu (TW); Yun-Tzuo Lai, Hsinchu (TW)

(73) Assignee: LITE-ON IT CORPORATION, Taipei (TW)

(21) Appl. No.: 13/413,843

(22) Filed: Mar. 7, 2012

(30) Foreign Application Priority Data
Oct. 31, 2011 (CN) 201110336553.0

(51) Int. Cl. G06F 12/00

(52) U.S. Cl. 711/103; 711/E12.008; 711/E12.017; 711/E12.023

(57) ABSTRACT

A method for controlling a cache memory of a solid state drive is provided. The solid state drive has a flash memory. The flash memory has a plurality of blocks, wherein each block has a plurality of pages. The method includes the following steps. Firstly, a refreshed data corresponding to a part of original data in a specified page of the flash memory is received and stored into a first cache unit. Then, the original data is read from the specified page, wherein an unrefreshed part of the original data is stored into the first cache unit, and a to-be-refreshed part of the original data is stored into a second cache unit. Afterwards, the refreshed data and the unrefreshed part of the original data in the first cache unit are stored into a blank page of the flash memory.

This application claims the benefit of People's Republic of China Application Serial No. 201110336553.0, filed Oct. 31, 2011, the subject matter of which is incorporated herein by reference.

### FIELD OF THE INVENTION

The present invention relates to a storage device, and more particularly to a solid state drive. The present invention also relates to a method for controlling a cache memory of the solid state drive.

### BACKGROUND OF THE INVENTION

As is well known, a solid state drive (SSD) is a data storage device that uses a NAND-based flash memory to store data. The NAND-based flash memory is a non-volatile memory. After data are written to the flash memory, if no power is supplied to the flash memory, the data are still retained in the flash memory.

FIG. 1 is a schematic functional block diagram illustrating a conventional solid state drive. As shown in FIG. 1, the solid state drive 10 comprises a controlling unit 101, a cache memory 107, and a flash memory 105. In the solid state drive 10, the controlling unit 101 is in communication with the flash memory 105 and the cache memory 107 for controlling the data-accessing operations of the flash memory 105 and the cache memory 107. In addition, the controlling unit 101 is in communication with a host 12 through an external bus 20. Consequently, commands and data can be exchanged between the controlling unit 101 and the host 12. Generally, the external bus 20 is a USB bus, an IEEE 1394 bus, an SATA bus, or the like.

The cache memory 107 is a buffering unit for temporarily storing the write data or the read data. In a case that no power is supplied to the cache memory 107, the data in the cache memory 107 will be deleted. The cache memory 107 is for example a static random access memory (SRAM) or a dynamic random access memory (DRAM).

Generally, the flash memory 105 comprises a plurality of blocks. Each block comprises a plurality of pages (or sectors), for example 64 pages. Each page is typically 8K bytes in size. Due to the inherent properties of the flash memory 105, at least one page is written at a time during the writing operation is performed, and the erasing operation is performed in a block-wise fashion.

Due to the inherent properties of the flash memory 105, if the data of a specified page of a block needs to be modified, the controlling unit 101 fails to directly correct the data of the page. Whereas, the data to be modified should be written into another blank page by the controlling unit 101. Under this circumstance, the old page is considered as an invalid page, and the data contained therein is considered as an invalid data.

FIG. 2 is a flowchart illustrating a method for controlling a data-refreshing operation of a cache memory of a conventional solid state drive. The cache memory comprises a plurality of cache units.

In a case that the host 12 wants to refresh a part of the data in a specified page of the flash memory 105, the host 12 will transmit the refreshed data to the solid state drive 10, and the controlling unit 101 will temporarily store the refreshed data into a first cache unit of the cache memory (Step S210). The refreshed data corresponds to the part of the original data of the specified page. Then, by the controlling unit 101, the original data in the specified page of the flash memory 105 will be temporarily stored into a second cache unit of the cache memory (Step S220). Then, the refreshed data in the first cache unit and the unrefreshed part of the original data in the second cache unit are combined together by the controlling unit 101, and the combined data are stored into a blank page of the flash memory 105 (Step 230). Afterwards, the first cache unit and the second cache unit are set as invalid cache units (Step S240).

FIGS. 3A˜3D schematically illustrate a process of moving the data of the solid state drive by the control method of FIG. 2. As shown in FIG. 3A, a first block (Block_1) of the flash memory comprises four pages P1, P2, P3 and P4. The first page P1 comprises the data D1, D2 and D3. The second page P2, the third page P3 and the fourth page P4 are blank pages. In addition, the cache memory 107 comprises at least two blank cache units Cm and Cn.

In a case that the host 12 wants to refresh a part of the data (e.g. the data D2) in the first page P1 of the first block (Block_1), the host 12 will transmit the refreshed data D2′ to the solid state drive 10, and the controlling unit 101 will temporarily store the refreshed data D2′ into the m-th cache unit Cm of the cache memory 107 along the path (I) as shown in FIG. 3B. The refreshed data D2′ corresponds to the part of the original data (e.g. the data D2) of the first page P1. Then, by the controlling unit 101, the original data (e.g. the data D1, D2 and D3) in the first page P1 of the first block (Block_1) are temporarily stored into the n-th cache unit Cn of the cache memory 107 along the path (II) as shown in FIG. 3B.

Then, along the path (III) as shown in FIG. 3C, the refreshed data D2′ in the m-th cache unit Cm and the unrefreshed part of the original data D1, D3 in the n-th cache unit Cn are combined together by the controlling unit 101, and the combined data (D1, D2′, D3) are stored into a blank page (e.g. the third page P3) of the first block (Block_1).

Then, the m-th cache unit Cm and the n-th cache unit Cn are set as invalid cache units by the controlling unit 101, and indicated as oblique lines. Of course, by the controlling unit 101, the combined data may be stored into another blank page of another block rather than the third page P3 of the first block (Block_1). In addition, the original first page P1 may be also set as an invalid page, and indicated as oblique lines.

Please refer to FIG. 3D. After the combined data (D1, D2′, D3) are stored into the third page P3 of the first block (Block_1) by the controlling unit 101, the data in the m-th cache unit Cm and the data in the n-th cache unit Cn are not identical to the data in the third page P3. Consequently, the data in the m-th cache unit Cm and the data in the n-th cache unit Cn fail to be used again, and may be set as invalid data. Moreover, the data in the m-th cache unit Cm and the data in the n-th cache unit Cn may be deleted by the controlling unit 101 at the right moment.

Then, if the host 12 issues a read command to read the third page P3 of the first block (Block_1), due to cache miss, the controlling unit 101 reads the data (D1, D2′, D3) from the third page P3 of the first block (Block_1) and temporarily stores the data into another cache unit (e.g. the p-th cache unit) of the cache memory. Then, the data (D1, D2′, D3) in the p-th cache unit will be transmitted from the p-th cache unit to the host 12.

### SUMMARY OF THE INVENTION

The present invention provides a solid state drive and a method for controlling a cache memory of the solid state drive. During a process of refreshing a specified page, the data allocation of the cache memory is controlled. Consequently, the control method is simplified, and the cache hit rate is increased.

A first embodiment of the present invention provides a method for controlling a cache memory of a solid state drive. The solid state drive has a flash memory. The flash memory has a plurality of blocks, wherein each block has a plurality of pages. The method includes the following steps. Firstly, a refreshed data corresponding to a part of original data in a specified page of the flash memory is received, and stored into a first cache unit. Then, the original data is read from the specified page, wherein an unrefreshed part of the original data is stored into the first cache unit, and a to-be-refreshed part of the original data is stored into a second cache unit. Afterwards, the refreshed data and the unrefreshed part of the original data in the first cache unit are stored into a blank page of the flash memory.

A second embodiment of the present invention provides a solid state drive. The solid state drive is in communication with a host, and includes a flash memory, a cache memory, and a controlling unit. The flash memory includes a plurality of blocks, wherein each of the blocks comprises a plurality of pages. The cache memory includes a plurality of cache units. The controlling unit is in communication with the flash memory and the cache memory. When a refreshed data corresponding to a part of original data in a specified page of the flash memory is received by the controlling unit, the refreshed data is stored into a first cache unit. After the original data is read from the specified page the controlling unit, an unrefreshed part of the original data is stored into the first cache unit and a to-be-refreshed part of the original data is stored into a second cache unit. The refreshed data and the unrefreshed part of the original data in the first cache unit are stored into a blank page of the flash memory by the controlling unit, so that the blank page is served as a refreshed page of the specified page.

A third embodiment of the present invention provides a method for controlling a cache memory of a solid state drive. The solid state drive has a flash memory. The flash memory has a plurality of blocks, wherein each block has a plurality of pages. The method includes the following steps. Firstly, a refreshed data is received and stored into a first cache unit of the cache memory. Then, a first data and a second data are read from a specified page of the flash memory, wherein the refreshed data corresponds to the second data. Then, the first data is stored into the first cache unit of the cache memory, and the second data is stored into a second cache memory of the cache memory. Afterwards, the refreshed data and the first data in the first cache unit are stored into a blank page of the flash memory.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (prior art) is a schematic functional block diagram illustrating a conventional solid state drive;

FIG. 2 (prior art) is a flowchart illustrating a method for controlling a data-refreshing operation of a cache memory of a conventional solid state drive;

FIGS. 3A˜3D (prior art) schematically illustrate a process of moving the data of the solid state drive by the control method of FIG. 2;

FIG. 4 is a flowchart illustrating a method for controlling a data-refreshing operation of a cache memory of a solid state drive according to an embodiment of the present invention; and

FIGS. 5A˜5E schematically illustrate a process of moving the data of the solid state drive by the control method of FIG. 4.

### DETAILED DESCRIPTION OF PREFERRED EMBODIMENTS

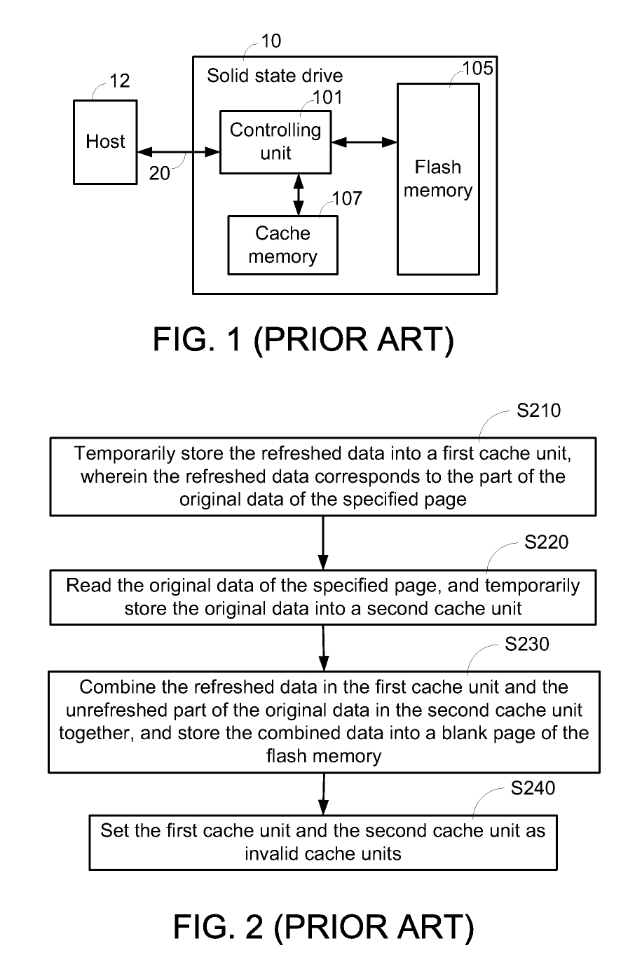

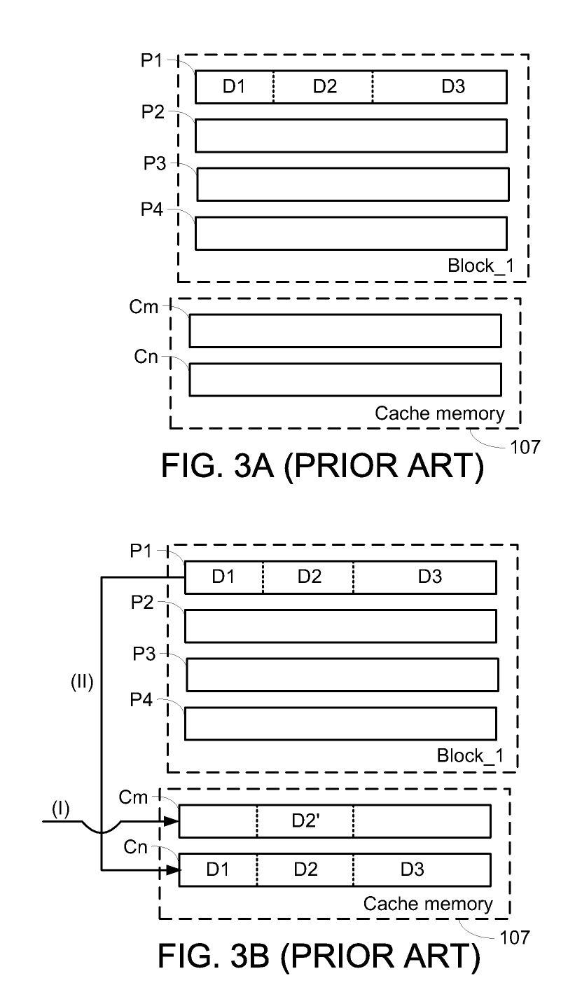

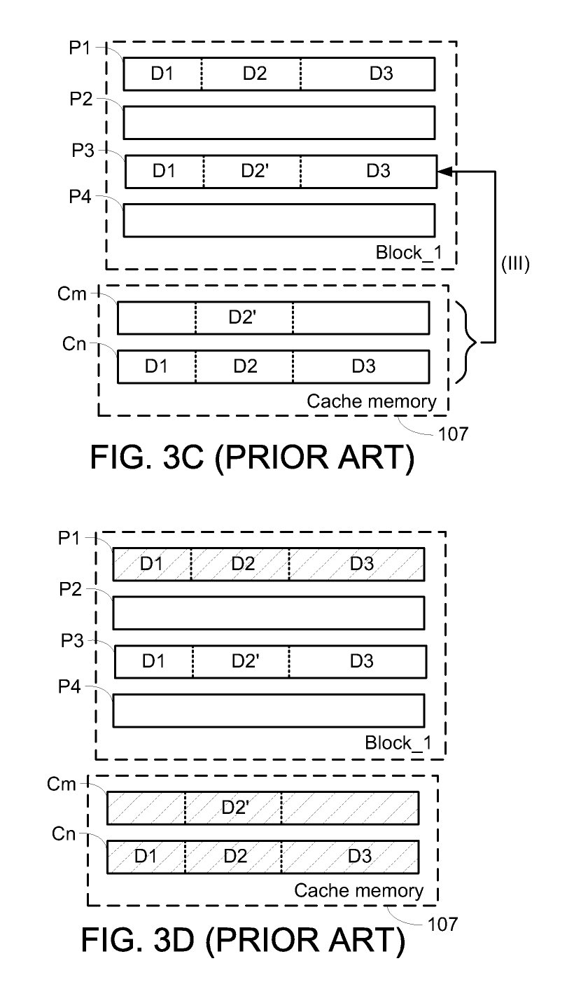

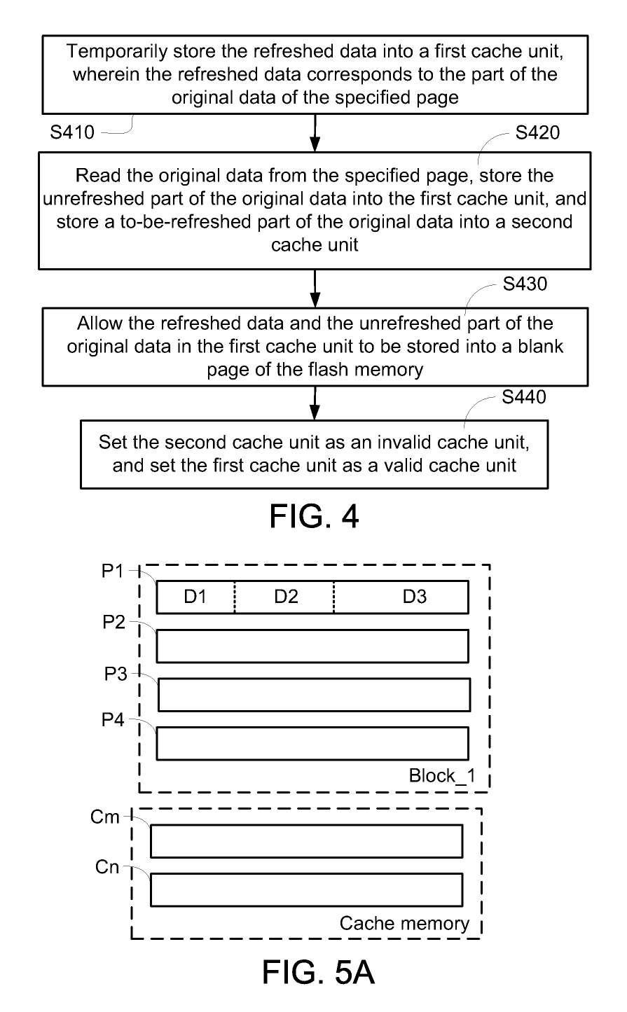

FIG. 4 is a flowchart illustrating a method for controlling a data-refreshing operation of a cache memory of a solid state drive according to an embodiment of the present invention. The solid state drive comprises a controlling unit, a cache memory, and a flash memory. The flash memory comprises a plurality of blocks. Each block comprises a plurality of pages. The cache memory comprises a plurality of cache units. The architecture of the solid state drive is similar to that of the solid state drive of FIG. 1, and is not redundantly described herein.

In a case that the host wants to refresh a part of the data in a specified page of the flash memory, the host will transmit the refreshed data to the solid state drive, and the controlling unit will temporarily store the refreshed data into a first cache unit of the cache memory (Step S410). The refreshed data corresponds to the part of the original data of the specified page. Then, the controlling unit reads the original data from the specified page of the flash memory, wherein the unrefreshed part of the original data is stored into the first cache unit, and a to-be-refreshed part of the original data is stored into a second cache unit of the cache memory (Step S420). Then, the refreshed data and the unrefreshed part of the original data in the first cache unit are stored into a blank page of the flash memory (Step S430). Afterwards, the second cache unit is set as an invalid cache unit, and the first cache unit is set as a valid cache unit (Step S440).

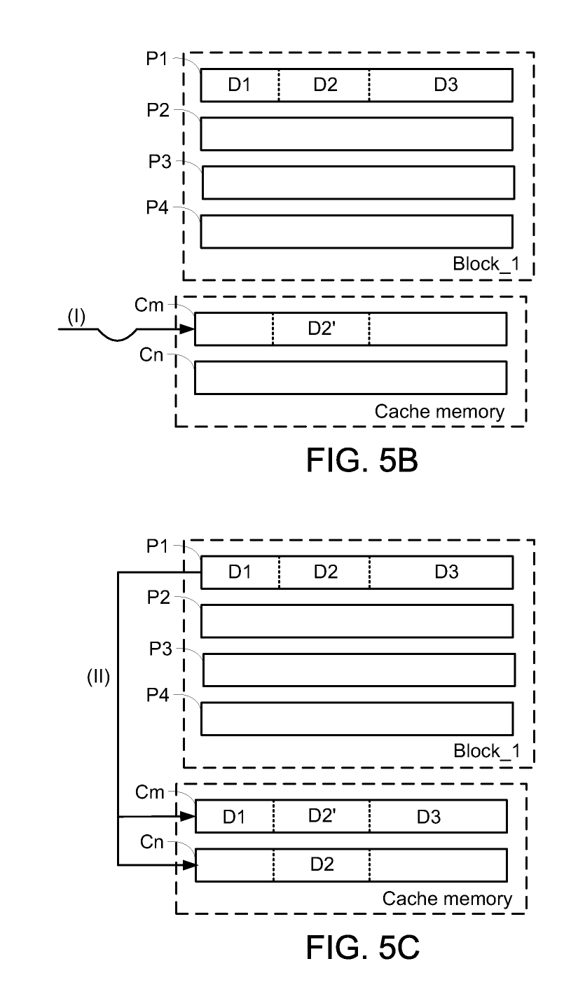

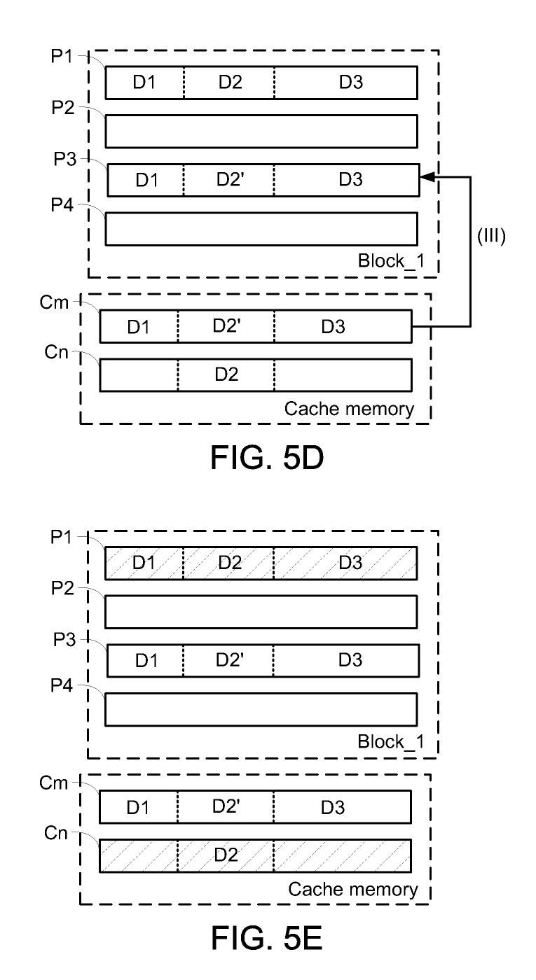

FIGS. 5A˜5E schematically illustrate a process of moving the data of the solid state drive by the control method of FIG. 4. As shown in FIG. 5A, a first block (Block_1) of the flash memory comprises four pages P1, P2, P3 and P4. The first page P1 comprises the data D1, D2 and D3. The second page P2, the third page P3 and the fourth page P4 are blank pages. In addition, the cache memory comprises at least two blank cache units Cm and Cn.

In a case that the host wants to refresh a part of the data (e.g. the data D2) in the first page P1 of the first block (Block_1), the host will transmit the refreshed data D2′ to the solid state drive 10, and the controlling unit 101 will temporarily store the refreshed data D2′ into the m-th cache unit Cm along the path (I) as shown in FIG. 5B. The refreshed data D2′ corresponds to the part of the original data (e.g. the data D2) of the first page P1.

Then, along the path (II) as shown in FIG. 5C, the controlling unit reads the original data (e.g. the data D1, D2 and D3) from the first page P1 of the first block (Block_1), wherein the unrefreshed part of the original data D1, D3 are stored into the m-th cache unit Cm, and the to-be-refreshed part of the original data D2 is stored into a n-th cache unit Cn.

Then, along the path (III) as shown in FIG. 5D, the refreshed data D2′ and the unrefreshed part of the original data D1, D3 in the m-th cache unit Cm are stored into a blank page (e.g. the third page P3) of the first block (Block_1) by the controlling unit.

Then, the controlling unit will set the n-th cache unit Cn as an invalid cache unit (indicated as oblique lines) and set the m-th cache unit Cm as the valid cache unit. Of course, by the controlling unit, the combined data may be stored into another blank page of another block rather than the third page P3 of the first block (Block_1). In addition, the original first page P1 may be also set as an invalid page, and indicated as oblique lines.

Please refer to FIG. 5E. After the combined data (D1, D2′, D3) are written into the third page P3 of the first block (Block_1) again by the controlling unit 101, the data in the n-th cache unit Cn are set as invalid data. In addition, the data in the n-th cache unit Cn are deleted by the controlling unit 101 at the right moment. Since the data in the m-th cache unit Cm are identical to those of the third page P3 of the first block (Block_1), the data in the m-th cache unit Cm are considered as valid data.

Then, if the host issues a read command to read the third page P3 of the first block (Block_1), the cache memory generates a message about cache hit. Consequently, the data (D1, D2′, D3) in the m-th cache unit Cm are directly transmitted from the cache unit to the host. That is, it is not necessary for the controlling unit to read the data (D1, D2′, D3) from the third page P3 of the first block (Block_1). Since the controlling unit does not need to read data from the flash memory again by the control method of the present invention, the systematic efficiency is enhanced.

From the above description, the present invention provides a method for controlling a cache memory of a solid state drive. For refreshing a specified page of the flash memory, the valid data (including the refreshed data and the unrefreshed part of the original data) are stored into the same cache unit, and the invalid data (including the to-be-refreshed part of the original data) are stored into another cache unit. Consequently, the cache hit rate is increased, and the read speed of the system is enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for controlling a cache memory of a solid state drive, the solid state drive having a flash memory, the flash memory having a plurality of blocks, each block having a plurality of pages, the method comprising steps of:
receiving a refreshed data corresponding to a part of original data in a specified page of the flash memory, and storing the refreshed data into a first cache unit of the cache memory;
reading the original data from the specified page, wherein an unrefreshed part of the original data is stored into the first cache unit, and a to-be-refreshed part of the original data is stored into a second cache unit; and
allowing the refreshed data and the unrefreshed part of the original data in the first cache unit to be stored into a blank page of the flash memory.

2. The method as claimed in claim 1, further comprising a step of setting the specified page of the flash memory as an invalid page.

3. The method as claimed in claim 1, further comprising a step of setting the second cache unit as an invalid cache unit, and setting the first cache unit as a valid cache unit.

4. A solid state drive in communication with a host, the solid state drive comprising:
a flash memory comprising a plurality of blocks, wherein each of the blocks comprises a plurality of pages;
a cache memory comprising a plurality of cache units; and
a controlling unit in communication with the flash memory and the cache memory,
wherein when a refreshed data corresponding to a part of original data in a specified page of the flash memory is received by the controlling unit, the refreshed data is stored into a first cache unit, wherein after the original data is read from the specified page the controlling unit, an unrefreshed part of the original data is stored into the first cache unit and a to-be-refreshed part of the original data is stored into a second cache unit, wherein the refreshed data and the unrefreshed part of the original data in the first cache unit are stored into a blank page of the flash memory by the controlling unit, so that the blank page is served as a refreshed page of the specified page.

5. The solid state drive as claimed in claim 4, wherein the controlling unit further sets the specified page of the flash memory as an invalid page.

6. The solid state drive as claimed in claim 4, wherein the controlling unit further sets the second cache unit as an invalid cache unit and sets the first cache unit as a valid cache unit.

7. A method for controlling a cache memory of a solid state drive, the solid state drive having a flash memory, the flash memory having a plurality of blocks, each block having a plurality of pages, the method comprising steps of:
receiving a refreshed data, and storing the refreshed data into a first cache unit of the cache memory;
reading a first data and a second data from a specified page of the flash memory, wherein the refreshed data corresponds to the second data;
storing the first data into the first cache unit of the cache memory, and storing the second data into a second cache memory of the cache memory; and
allowing the refreshed data and the first data in the first cache unit to be stored into a blank page of the flash memory.

8. The method as claimed in claim 7, further comprising a step of setting the specified page of the flash memory as an invalid page.

9. The method as claimed in claim 7, further comprising a step of setting the second cache unit as an invalid cache unit, and setting the first cache unit as a valid cache unit.

10. The method as claimed in claim 7, wherein the first data is an unrefreshed part of the original data in the specified page, and the second data is a to-be-refreshed part of the original data in the specified page.
